(19) United States
(12) Patent Application Publication
(10) Pub. No.: US 2021/0349787 A1
(43) Pub. Date: Nov. 11, 2021

(54) CUSTOMER SPECIFIC BACKUP OBJECT SIZES

(71) Applicant: SAP SE, Walldorf (DE)

(72) Inventors: Stefan Voss, Postsdam (DE); Anne Roessiger, Walldorf (DE); Benedikt Klus, Hamburg (DE); Martin Brunzema, Berlin (DE); Henrik Hempelmann, Havelberg (DE)

(21) Appl. No.: 16/870,368

(22) Filed: May 8, 2020

(51) Int. Cl. G06F 11/14; G06F 9/54

(52) U.S. Cl. CPC G06F 11/1464; G06F 2201/80; G06F 9/547

(57) ABSTRACT

A system and method providing a reception of metrics related to data storage processes of a plurality of different service instances deployed on a cloud services infrastructure providing data storage space for the plurality of database service instances; determining an amount of the data storage space consumed by a first database service instance; and storing a record of the determined amount of the data storage space consumed by the first database service instance in a persistent data storage device that is distinct and separated from the cloud services infrastructure. The system and method further reporting, on demand, the amount of the data storage space determined consumed by the first database service at a particular time

### BACKGROUND

Many modern computing deployments generate extraordinarily large amounts of data. The storage of this data consumes a tremendous amount of storage and compute resources. The costs and time for an organization to build out the infrastructure to support their present and future storage and compute needs might very well exceed their abilities and/or capabilities. This is particularly true as more and more systems revolve around cloud services.

A number of large cloud infrastructure and service providers have emerged and continue to come into existence that may provide the infrastructure to support customers in need of robust and reliable storage and compute needs. A benefit offered by these providers is that their systems are scalable, responsive to their customers' needs. These large cloud infrastructure and service providers may provide an incredibly large amount of storage that can be used to accommodate the customers individually and aggregately, scaling up and out as need be to accommodate increasing storage and processing requirements. In some regards, backup of an organization's data system(s) is vitally important to the operation of an enterprise, in case of system outages and other customer critical situations involving potential data loss and/or data inconsistencies. Large cloud infrastructure and service providers might provide a remote storage location for customer data backups, while also offering improved resilience and availability of the backups.

Large cloud infrastructure and service providers may host services and storage for hundreds of thousands or even millions of customers. It is important for the cloud infrastructure and service providers to know how much storage their current and potential customers may need in the aggregate so that they can allocate and scale storage, as and when needed, to meet their customers' requirements. However, there exists a need for an accurate determination and reporting of the storage consumption of each of the customers of a large cloud infrastructure and service provider environment.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an architecture for a cloud infrastructure and service provider, in accordance with an example embodiment.

FIG. 2 is a block diagram illustrating some aspects of a data interface, in accordance with an example embodiment.

FIG. 3 is a block diagram of an architecture of a customer specific backup storage consumption determination and reporting system, in accordance with an example embodiment.

FIG. 4 is an illustrative flow diagram of a backup storage consumption determination process, in accordance with an example embodiment.

FIG. 5 is an illustrative flow diagram of a backup storage consumption reporting process, in accordance with an example embodiment.

FIG. 6 is an illustrative diagram of an outward facing user interface related to a backup storage consumption system and process, in accordance with an example embodiment.

FIG. 7 is an illustrative representation of a database related to a backup storage consumption system and process herein, in accordance with an example embodiment.

FIG. 8 is an illustrative block diagram of a computing system, in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the present disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

As used herein, the term “hyperscaler” refers to a company or other entity that provides, for example, public cloud and cloud service industries, although other services and businesses might also be provided. Hyperscalers provide cloud storage and compute infrastructures on a scale (i.e., size and extent) that far exceeds that of typical data centers. Hyperscalers may provide, maintain, and upgrade the infrastructure, including hardware, (customized) software, facilities, power management systems, etc. to provide services to customers with improved uptime. While Hyperscalers might provide a number of different services to end users (e.g. customers), aspects related to the data storage provided by a hyperscaler are, in some embodiments, significant to the present disclosure.

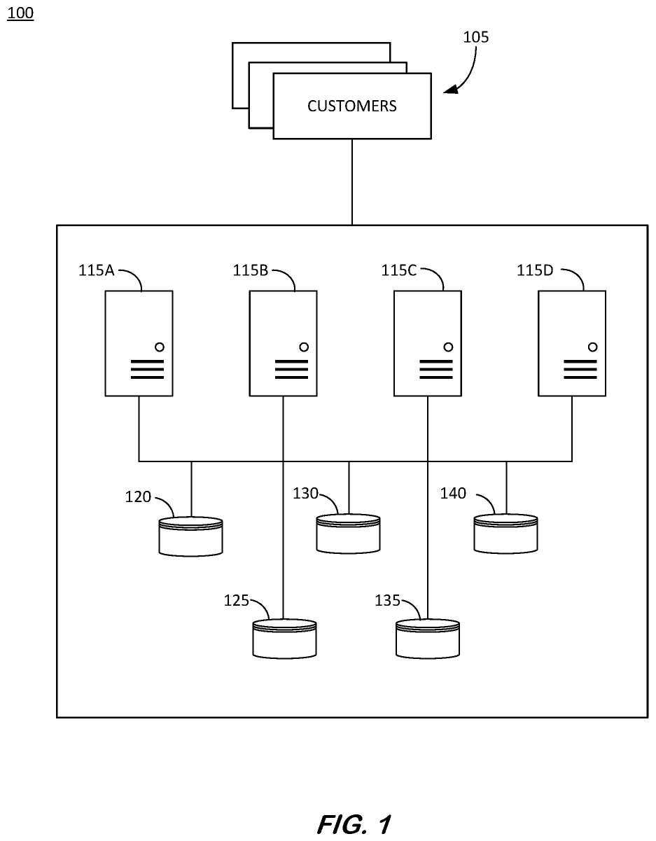

FIG. 1 is a high level illustrative depiction of a hyperscaler architecture 100, in accordance with an embodiment herein. A hyperscaler 110 includes all of the hardware, software, networks, facilities, energy management systems, and other operational aspects, whether custom or commodity acquisitions, to enable and support large cloud infrastructure and services for large numbers of users 105 (e.g., millions of customers of hosted services). All of these different aspects of the hyperscaler are not shown in FIG. 1. FIG. 1 includes illustrative representations of the many (e.g., >100,000) servers and storage devices implemented by the example hyperscaler that support the massive storage and compute capabilities of the its cloud infrastructure. Shown are servers 115A, 115B, 115C, and 115D that are networked to each other and to data storage devices/systems 120, 125, 130, 135, and 140. The servers and data storage devices depicted in FIG. 1 may include redundancies of some or all of each other to provide, in conjunction with certain executable processes, the reliability and resiliency of the hyperscaler environment 100. Additionally, FIG. 1 is an illustrative, figurative representation of hyperscaler servers and data storage devices/systems, as opposed to an actual physical or logical configuration thereof. In some aspects, the features of customer specific data backup consumption determination and reporting disclosed herein are not limited to any particular configuration or implementation of a hyperscaler.

Hyperscaler 100 may host a database for one or more of customers 105 in the cloud provided by its cloud infrastructure, where the database is provided as a service to the clients (i.e., Database-as-a-Service, DBaaS). In some aspects, the database offered by hyperscaler 100 stores backups for database service instances in an object storage where the backups (i.e., data) are stored as distinct “objects”. Referring to the example of FIG. 1, the object storage may be provided and maintained by the storage devices/systems 120, 125, 130, 135, and 140, in part and/or different combinations.

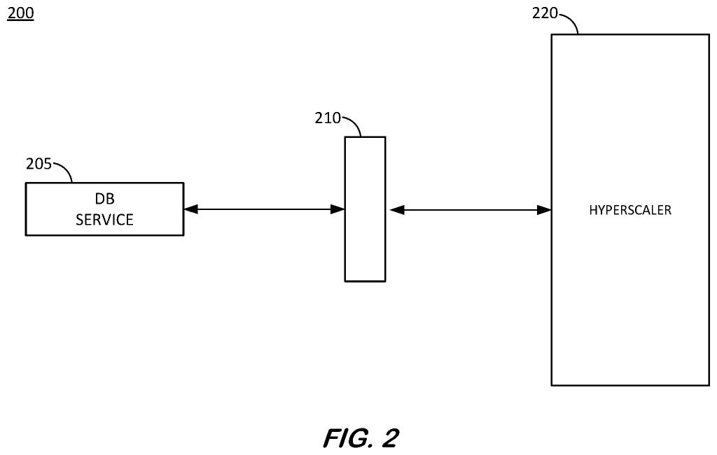

In some aspects, a database service instance might not know where or how its backups are actually stored. The database service instance may know that it makes a request to have a backup stored and might receive a confirmation or other indication that the backup is saved, but where the backup is actually stored can be beyond the scope of the database service instance. FIG. 2 is an illustrative depiction of some aspects of an architecture related to the storage of a backup for a database (or other) service instance in a hyperscaler environment, in some example embodiments. Database service instance 205 may store some data locally in, for example, an on-promise data store (not shown) or in an object store of hyperscaler 220. Database service instance 205 may connect to hyperscaler 220 via a backend interface 210 to write the backup directly to the cloud storage of the hyperscaler. In some aspects, backend interface is an abstract interface of architecture 200 and decouples the database service instance from hyperscaler 220 such that database service instance 205 has no knowledge or awareness of the actual storage location and mechanisms (e.g., data compression schemes, incremental, delta, etc.) used to store its data in the hyperscaler environment. Thus, in some embodiments, a database service instance might know how many bytes of data are sent to the hyperscaler from its perspective or side but does not know how much storage space is actually consumed on the cloud storage provider (i.e., hyperscaler) side since one or more different processes may be used by the cloud storage provider, where the amount of storage actually consumed by storing the database service instance backup may be different (e.g., more or less) than the amount of data written to backend interface 210 by the database service instance. The mechanisms or processes that occur behind the interface, including how the backup is processed and transferred to the cloud service, are not known by the database service instance. In some instances, the database service instance might not know to which cloud service provider the backup is transferred.

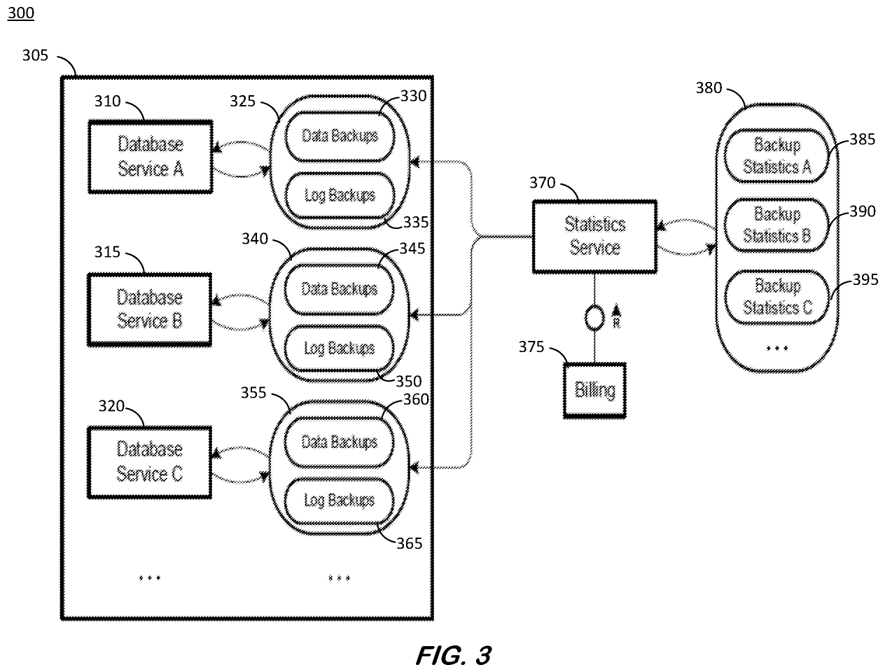

FIG. 3 is a block diagram of an architecture or framework 300 including a customer specific backup storage consumption determination and reporting system, in accordance with an example embodiment. Architecture or framework 300 includes a hyperscaler environment 305 that hosts a number of database services for a plurality of different customers/users. In the example of FIG. 3, the database service instances supported by the hyperscaler include, for illustrative purposes, database service instances “Database Service A” 310, “Database Service B” 315, and “Database Service C” 320. In some embodiments, each of the database service instances writes backups to a cloud storage (e.g., object storage) of hyperscaler 305. The backups of the database service instances may comprise different aspects or components, including, in some embodiments, a data backup portion and a log backup portion including details regarding the backup process of a respective backup. In the example of FIG. 3, backups 325 for database service instance 310 are written to hyperscaler storage and comprises data backups 330 and log backups 335, backups 340 for database service instance 315 are written to cloud storage of hyperscaler 305 and include data backups 345 and log backups 350, and backups 355 of database service instance 320 are written to the cloud storage as data backups 360 and log backups 365.

In some aspects, hyperscaler 305 includes many more database service instances for storing corresponding backups than the few examples depicted in FIG. 3. In some other aspects, the particular configuration or representation of a backup or other data structure stored by the cloud storage of hyperscaler 305 for a database (or other) service instance herein might vary from the particular backup configurations including data backups and log backups shown in IFG. 3, where other configurations may include, fewer, more, substitute, or alternative components.

In some embodiments, a service 370 is provided that interfaces with hyperscaler environment 305 to obtain or otherwise gather indications or representations of one or more metrics related to the storage of backups stored in the cloud storage of hyperscaler environment 305. In some aspects, the one or more metrics related to the storage of backups may be processed, analyzed, or otherwise used by service 370 to determine an accurate calculation of the amount of storage space consumed by each backup stored for the different database service instances 310, 315, and 320. In some embodiments, the one or more metrics gathered or retrieved from hyperscaler 305 relate to the size of each object stored or written to the object store of the hyperscaler environment. Note that the one or more metrics gathered for each stored object includes an indication, in some discernable form, of the size of each object stored in the object store and the database service instance to which the backup belongs. In some aspects, the service 370 processes the one or more gathered metrics related to the storage of backups to accurately determine a size of each object stored in the hyperscaler's object store. In some embodiments, service 370 may be referred to a statistics service since it may review, analyze, and determine the amount of cloud storage consumed by each object for each database service instance based on the gathered one or more metrics related to the storage of the database service instances' backups.

In some embodiments, statistics service 370 may periodically gather the one or more metrics data related to the storage of backups to determine the size of each object stored in the cloud storage. The frequency of the data gathering periods may be predetermined to, for example, every four hours, every 12 hours, every 24 hours, etc.). The particular time period may be set by an administrative (or other) entity. In some instances, the time period may be based, at least in part, the type of service writing the backups, the customer of the provided service, the efficiency and/or other operational constraints of the hyperscaler provider of hyperscaler environment 305, and other factors, alone or in combination with one or more other factors. In some aspects, the periodic gathering of metrics related to the stored backups provides an indication of the size of the objects stored at the time the one or more metrics are gathered or otherwise retrieved from the hyperscaler. Based on the periodic gathering of the one or more metrics related to the storage of backups (e.g., objects) for each database service instance, statistics service 370 may further determine, by summing in some embodiments the determined (i.e., calculated) size for the individual backups for a given database service instance to obtain or otherwise determine a value for the total storage space consumption for the given database service instance. In some embodiments, statistics service 370 may operate to determine the storage consumption of each database service instance for any time period for which the statistics service performs the functions disclosed herein.

In some embodiments, the gathering or otherwise retrieval of the one or more metrics is facilitated by, for example, using an application programming interface (API) offered by the hyperscaler 305 (i.e., the provider of the cloud object (or other) storage consumed by the database service instances).

In some aspects and embodiments, the consumption information and data periodically determined and analyzed is stored in a persistent memory system or device 380. Note that, in some embodiments, persistence 380 is separate and distinct from the hyperscaler 305. In some embodiments, persistence 380 includes a representation of the backup statistics for each of the database (or other) service instances consuming object (or other) storage of the hyperscaler. In the example of FIG. 3, persistence 380 includes a record or other data structure including representation(s) of the cloud storage space consumed by database service instance 310 at 385, the cloud storage space consumed by database service instance 315 at 390, and the cloud storage space consumed by database service instance 320 at 395. In some aspects, persistence 380 might include a record or other data structure representation(s) of the cloud storage space consumed by each of the database (or other) service instances using object (or other) storage of the hyperscaler.

In some aspects, a reporting or other service 375 may periodically and/or selectively make a request against statistics service 370 for the record or other data structure representations including the consumption information and data periodically determined and analyzed for a particular one or more database service instances. In some embodiments, the reporting service 380 might include a billing service or application. In some instances, the consumption information or data determined for each database service may be retrieved by the statistics service 370 from its persistence and provided to billing service or application 375 in reply to a request for such information or data by the billing service. In some instances, reporting, billing, or other service implementations 375 may be a third-party service or application (i.e., neither of the hyperscaler 305 or statistics service 370). The billing service or application 375 may generate a bill for the one or more database service instances consuming cloud storage of the hyperscaler, where the bill is calculated based on the one or more metrics gathered directly from the hyperscaler and used to accurately determine the actual storage space consumed by each object stored by each database service instance. The calculated, consumed storage space for each database service instance may be reported to the customers to whom the cloud based database (or other) services are offered.

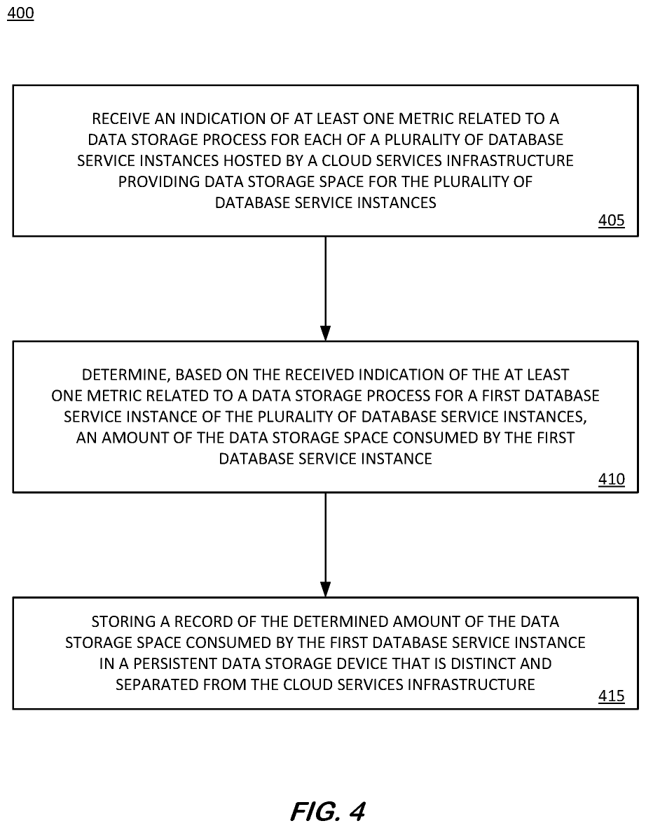

FIG. 4 is an illustrative flow diagram of a backup storage consumption determination process 400, in accordance with an example embodiment. In some aspects, process 400 may be executed, at least in part and some instances, by a system disclosed herein including aspects of an architecture and hyperscaler environment such as, but not limited to, for example, FIG. 3. At operation 405, an indication of at least one metric related to a data storage process for each of a plurality of database service instances is received. Referring to FIG. 3, the indication of the at least one metric may be received by statistics service 370. Moreover, the at least one metric may be received by statistics service 370 from hyperscaler 305 in reply to a periodic request for such information and data from the statistics service. In some aspects, the request from statistics service 370 and the reply transmitted to statistics service 370 may be accomplished, in part, by an API offered by the hyperscaler environment. The request may be configured to gather a current consumption of cloud (e.g., object) storage for backups for each of the one or more database (or other) service instances hosted in a hyperscaler environment.

Operation 410 includes determining, in response to and based on the indication of the at least one metric received at operation 405 for a first database (or other) service instance of the plurality of database (or other) service instances hosted by the hyperscaler environment, an accurate size (i.e., amount) of the cloud storage consumed by the first database (or other) service instance.

Advancing to operation 415, a record or other data structure representation is persisted in a storage associated with the statistics (or other) service initiating or otherwise managing the request that prompted the retrieval or gathering of storage consumption metric(s) at operation 405. The record stored at operation 415 relates to the first database (or other) service instance referenced in operation 410. In some embodiments, operations 410 and 415 may be iteratively repeated for each of the plurality of database (or other) service instances for which storage consumption metric(s) were retrieved at operation 405.

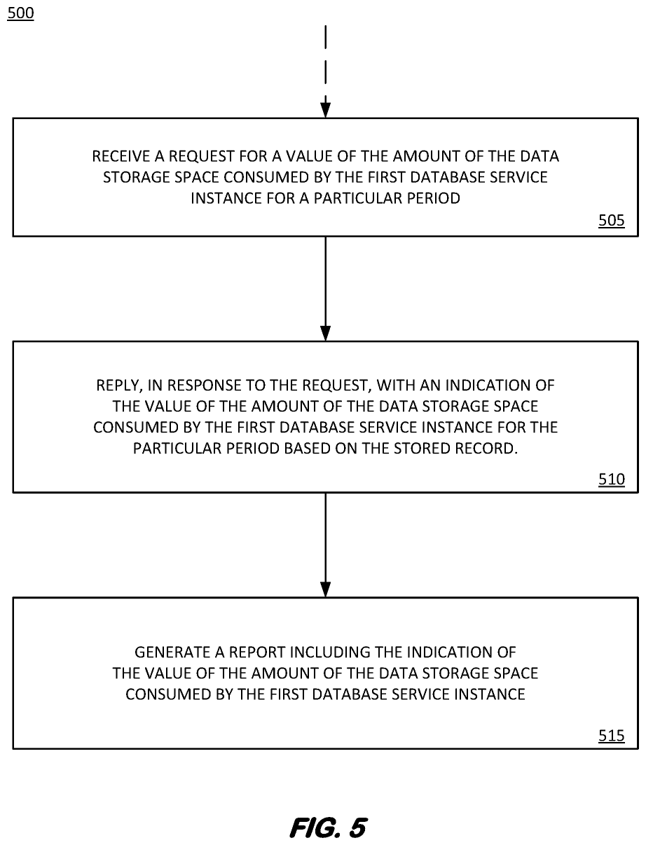

FIG. 5 is an illustrative flow diagram of a backup storage consumption reporting process 500, in accordance with an example embodiment. Prior to the execution of operation 505 by a system including or interfacing with a hyperscaler environment (e.g., system 300 of FIG. 3), a record or other data structure representation including an indication of a value representing the space consumed by each of a plurality of database (or other) service instances hosted by the hyperscaler environment is generated and persisted (e.g., by a statistics (or other) service (e.g., FIG. 3, 370)). This aspect is conveyed by the arrow pointing into operation 505.

At operation 505, a request (i.e., a query) for a value representing the amount of cloud storage space consumed by a first database (or other) service instance is received. In some embodiments, the request may be generated and received from a third-party reporting service, such as, for example a billing service that operates to, at least in part, generate bills or other reports for a user (i.e., customer) based on the actual cloud storage space consumed by the service(s) provided to the user by the hyperscaler.

At operation 510, a response to the request of operation 505, is generated. The response might be generated by processes that automatically execute in response to a receipt of the request of operation 505. These processes may be executed by a statistics (or other) service herein (FIG. 3, 370) that references an associated data storage facility storing records of the space consumed by each of a plurality of database (or other) service instances, where the records are periodically generated (and updated) over a span of time.

Operation 515 includes generating a report (i.e., bill) that reflects the actual cloud storage space consumed by the first database (or other) service instance. In some embodiments, the generated report may include other types of reports, in addition to or instead of, a bill charging a customer a fee corresponding to the actual cloud storage consumed by services provided to the customer.

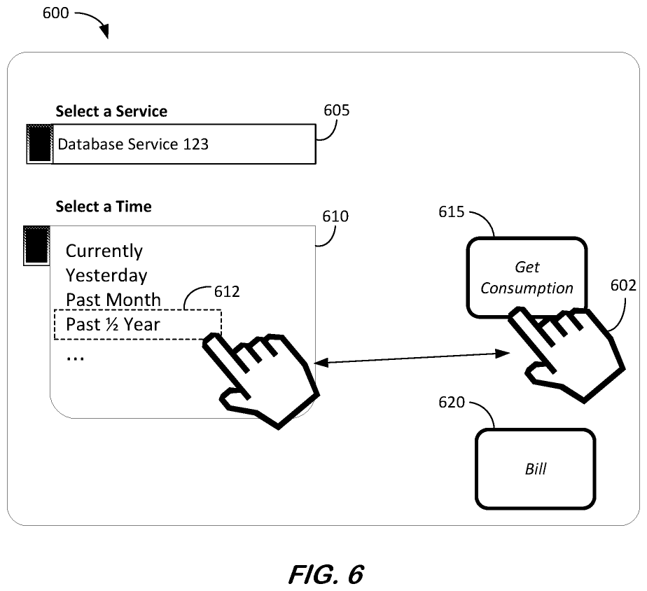

FIG. 6 is an illustrative diagram of an outward facing user interface (UI) 600 related to a backup storage consumption determination and reporting system and process, in accordance with an example embodiment. UI 600 may be displayed within a display device associated with a statistics (or other) service or a display device independent of the statistics (or other) service (e.g., a display of a device or system in communication with statistics (or other) service over a network via a browser application). Selection of one or more UI elements (e.g., icons, buttons, drop-down menu options, etc.) by a touchscreen input, computer pointer 602, etc. may result in the initiation or continuance of the determination of cloud storage consumed by a database (or other) service instance (e.g., the selection of “Get Consumption” button 615) or the initiation or continuance of the reporting of the cloud storage consumed by a database (or other) service instance (e.g., the selection of “Bill” button 620). In the example of FIG. 6, UI 600 includes a UI element 605 for selecting a particular service (e.g., a particular database (or other) service instance for which the actual cloud storage consumption is desired. Additionally, UI 600 includes a drop-down menu 610 that may facilitate selection and entry of a particular time period for which a report (e.g., bill) is to be generated.

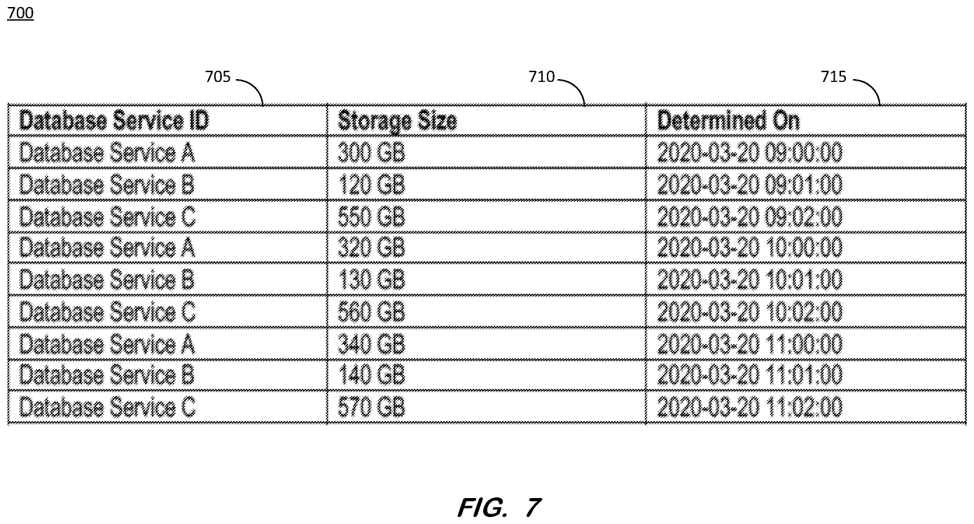

FIG. 7 is an illustrative representation of a database related to a backup storage consumption system and process herein, in accordance with an example embodiment. A table 700 is shown that represents a backup statistics database that may be stored according to some embodiments. The table may include, for example, entries detailing services hosted by a hyperscaler and the storage space consumed by each service. For example, table 700 defines field 705 for a database service ID that uniquely identifies each database service within the particular hyperscaler environment, a storage size 710 that represents the cloud storage consumed by a particular database service instance at a particular time, as defined by data field 715. Entries in database table 700 may be generated in response to the execution of the one or processes disclosed herein.

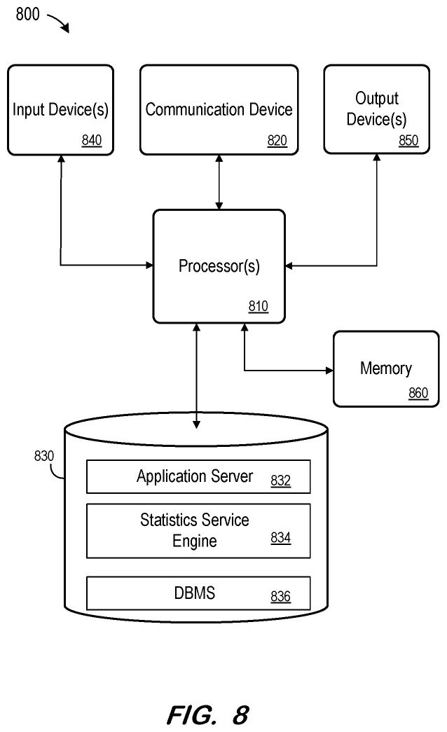

FIG. 8 illustrates a computing system 800 that may be used in any of the architectures or frameworks (e.g., FIGS. 2, 3) and processes (e.g., FIGS. 4, 5) described herein, in accordance with an example embodiment. FIG. 8 is a block diagram of server node 800 embodying a central statistics service, according to some embodiments. Server node 800 may comprise a general-purpose computing apparatus and may execute program code to perform any of the functions described herein. Server node 800 may comprise an implementation of at least some features of architecture 200 of FIG. 2 in some embodiments. Server node 800 may include other unshown elements according to some embodiments.

Server node 800 includes processing unit(s) 810 operatively coupled to communication device 820, data storage device 830, one or more input devices 840, one or more output devices 850, and memory 860. Communication device 820 may facilitate communication with external devices, such as an external network or a data storage device. Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to enter information into apparatus 800. Output device(s) 850 may comprise, for example, a display (e.g., a display screen) a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 860 may comprise Random Access Memory (RAM).

Application server 832 may each comprise program code executed by processor(s) 810 to cause server 800 to perform any one or more of the processes described herein. Statistics service engine 834 may execute one or more processes to gather, review, analyze, and store consumption related data to determine and report on the size of cloud storage consumed by respective database (or other) service instances. Embodiments are not limited to execution of these processes by a single computing device. Data storage device 830 may also store data and other program code for providing additional functionality and/or which are necessary for operation of server 800, such as device drivers, operating system files, etc. DBMS 836 may store and manage a variety of data types and structures, including, for example, consumption related data.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system comprising:
a memory storing processor-executable program code; and
a processor to execute the processor-executable program code in order to cause the system to:
receive an indication of at least one metric related to a data storage process for each of a plurality of database service instances, the plurality of database service instances being hosted by a cloud services infrastructure providing data storage space for the plurality of database service instances;
determine, based on the received indication of the at least one metric related to a data storage process for a first database service instance of the plurality of database service instances, an amount of the data storage space consumed by the first database service instance; and
store a record of the determined amount of the data storage space consumed by the first database service instance in a persistent data storage device that is distinct and separated from the cloud services infrastructure.

2. The system of claim 1, wherein the determining of the amount of the data storage space consumed is executed for each of the plurality of database service instances.

3. The system of claim 1, wherein the data backup comprises both a data backup component and a log backup component.

4. The system of claim 1, wherein the data storage process relates to a data backup for each respective database service instance of the plurality of database service instances.

5. The system of claim 1, further comprising:
receiving a request for a value of the amount of the data storage space consumed by the first database service instance for a particular period; and
replying, in response to the request, with an indication of the value of the amount of the data storage space consumed by the first database service instance for the particular period based on the stored record.

6. The system of claim 5, wherein the request is received from and the response is provided to a reporting service.

7. The system of claim 1, wherein an application programming interface (API) of the cloud services infrastructure is used in making a request for the indication of the at least one metric.

8. A computer-implemented method, the method comprising:
receiving an indication of at least one metric related to a data storage process for each of a plurality of database service instances, the plurality of database service instances being hosted by a cloud services infrastructure providing data storage space for the plurality of database service instances;
determining, based on the received indication of the at least one metric related to a data storage process for a first database service instance of the plurality of database service instances, an amount of the data storage space consumed by the first database service instance; and
storing a record of the determined amount of the data storage space consumed by the first database service instance in a persistent data storage device that is distinct and separated from the cloud services infrastructure.

9. The method of claim 8, wherein the determining of the amount of the data storage space consumed is executed for each of the plurality of database service instances.

10. The method of claim 8, wherein the data backup comprises both a data backup component and a log backup component.

11. The method of claim 8, wherein the data storage process relates to a data backup for each respective database service instance of the plurality of database service instances.

12. The method of claim 8, further comprising:
receiving a request for a value of the amount of the data storage space consumed by the first database service instance for a particular period; and
replying, in response to the request, with an indication of the value of the amount of the data storage space consumed by the first database service instance for the particular period based on the stored record.

13. The method of claim 12, wherein the request is received from and the response is provided to a reporting service.

14. The method of claim 8, wherein an application programming interface (API) of the cloud services infrastructure is used in making a request for the indication of the at least one metric.

15. A non-transitory, computer readable medium storing instructions, which when executed by at least one processor cause a computer to perform a method comprising:
receiving an indication of at least one metric related to a data storage process for each of a plurality of database service instances, the plurality of database service instances being hosted by a cloud services infrastructure providing data storage space for the plurality of database service instances;
determining, based on the received indication of the at least one metric related to a data storage process for a first database service instance of the plurality of database service instances, an amount of the data storage space consumed by the first database service instance; and
storing a record of the determined amount of the data storage space consumed by the first database service instance in a persistent data storage device that is distinct and separated from the cloud services infrastructure.

16. The medium of claim 15, wherein the determining of the amount of the data storage space consumed is executed for each of the plurality of database service instances.

17. The medium of claim 15, wherein the data backup comprises both a data backup component and a log backup component.

18. The medium of claim 15, wherein the data storage process relates to a data backup for each respective database service instance of the plurality of database service instances.

19. The medium of claim 15, further comprising:
receiving a request for a value of the amount of the data storage space consumed by the first database service instance for a particular period; and
replying, in response to the request, with an indication of the value of the amount of the data storage space consumed by the first database service instance for the particular period based on the stored record.

20. The medium of claim 15, wherein an application programming interface (API) of the cloud services infrastructure is used in making a request for the indication of the at least one metric.
